(19) United States
(12) Patent Application Publication
(10) Pub. No.: US 2013/0339030 A1
(43) Pub. Date: Dec. 19, 2013

(54) INTERACTIVE SPOKEN DIALOGUE INTERFACE FOR COLLECTION OF STRUCTURED DATA

(71) Applicant: Fluential, LLC, Sunnyvale, CA (US)

(72) Inventors: Farzad Ehsani, Sunnyvale, CA (US); Silke Maren Witt-Ehsani, Sunnyvale, CA (US)

(21) Appl. No.: 13/917,519

(22) Filed: Jun. 13, 2013

Related U.S. Application Data
(60) Provisional application No. 61/659,201, filed on Jun. 13, 2012.

(51) Int. Cl. G10L 17/00

(52) U.S. Cl. CPC G10L 17/005
USPC 704/275

(57) ABSTRACT

A multimodal dialog interface for data capture at point of origin is disclosed. The interface is designed to allow loading of forms needed for task record keeping, and is therefore customizable to wide range of record keeping requirements such as medical record keeping or recording clinical trial. The interface has a passive mode that is able to capture data while the user is performing other tasks, and an interactive dialog mode that ensures completion of all required information.

This application claims the benefit of priority to U.S. provisional application having Ser. No. 61/659,201 filed Jun. 13, 2012. This and all other extrinsic materials discussed herein are incorporated by reference in their entirety.

### FIELD OF THE INVENTION

The field of the invention is human-computer user interfaces.

### BACKGROUND

The following description includes information that may be useful in understanding the present invention. It is not an admission that any of the information provided herein is prior art or relevant to the presently claimed invention, or that any publication specifically or implicitly referenced is prior art.

Collecting clinical or research data accurately and efficiently is an important problem for many organizations. Capturing immediate record keeping, as information becomes available, supports high accuracy, but can severely interrupt workflow. In high workload situations, it is very challenging to give tedious or difficult record creation and maintenance processes high priority. One example of this problem is creating and maintaining health records, which is a burdensome and time consuming task for health care providers. In the advent of US requirements for electronic medical record formats; (see the Federal Register Volume 77, Number 45; Wednesday, Mar. 7, 2012 URL www.gpo.gov/fdsys/pkg/FR-2012-03-07/html/2012-4430.htm), easing the burden of obtaining patient information into the required formats has become business critical. It has also increased the cost of health care delivery. As a group, health care providers are resistant to adopting information technology in general. Slow rates of Electronic Health Record (EHR) adoption are consistent with this pattern.

Another example of the problem is in data collection for clinical trials. This data must also be collected in a particular format and the success of the study depends on accurate records. An additional complication is that most of the clinical trials are being outsourced and conducted outside the United States, in potentially difficult field conditions.

Addressing the problem of point of collection capture of information, and the translation of that information into structured records, requires an intuitive data entry method that (1) minimizes interruption to the work flow, (2) is fast, (3) requires minimum effort, (4) requires minimal skill sets, (5) has high accuracy and (6) is readily available. It has yet to be appreciated that two approaches to addressing the problem are (1) to introduce a more natural modality and (2) to capture as much data as possible passively while the user is performing other duties. Spoken input in conjunction with natural language understanding (NLU) and dialog interaction management has potential for enabling both of these approaches.

Prior work exists on using speech input for point of care data entry (U.S. patent 2008/0154598 A1 to Kevin L. Smith titled “Voice Recognition System for Use in Health Care Management System”, filed Jun. 26, 2008). In this approach, data is displayed visually as an electronic representation of a traditional paper medical record. The system uses a GUI menu-driven interactive method, and a separate dictation data entry step. Dictation is first processed with an automatic speech recognition system. The results are then processed and edited by a human transcriptionist. However, the work fails to provide a natural interface to the user, requiring instead the use of a complex menu-driven interface. Thus, interaction with the system cannot be done without interrupting the user's workflow. The dictation phase is slow and introduces an extra cost as well as a time delay because the recognition phase and data update is not real-time. Also, out of the many screens and options available to the user, there is only one screen that allows for recording audio to be sent later to a voice recognition engine.

Prior research also exists on using speech recognition to fill appropriate data fields in a call center system (U.S. Pat. No. 6,510,414 B1 to Gerardo Chavez titled “Voice Recognition System for Use in Health Care Management System”, filed Jan. 21, 2003). This work is for a system that does partial completion and then passes the information to a human agent. The work is not designed for mobile devices however. In addition, this system fails to provide an automated method for ensuring form completion and does not support the capture of information in the natural course of conducting a simultaneous activity.

Additional efforts directed to the use of natural language processing for creating medical records (Johnson, Stephen B, et al. “An Electronic Medical Record Based on Structured Narrative”, Journal of the American Medical Informatics Association, v.15(1), January-February 2008) focus on the form of data to be captured rather than the capture method, and lack a method for capturing data without interrupting workflow.

U.S. Pat. No. 7,739,117 B2 to Ativanichayaphong et al. titled “Method and System for Voice-Enabled Autofill”, issued Jun. 15, 2010, specifically describes a process of automatically filling a form by the conversion of utterances into text. Further, the work describes the creation and use of form field specific grammars. This work however fails to describe the selection and use of domain rule sets for tagging input speech and for providing rules for the construction of field objects. Additionally, the work does not claim the use of domain rule sets for the construction of field objects as a method for more accurate and intelligent form completion.

U.S. Patent Application US 2007/0124507 A1 to Gurram et al. titled “Systems and Methods of Processing Annotations and Multimodal User Inputs”, published May 31, 2007, describes a multimodal input capability. It discusses the selection of input fields and a method for permitting users to input information via a voice or speech mode. The system is capable of prompting a user for a plurality of inputs, receiving a voice command or a touch screen command specifying one of the plurality of inputs, activating a voice and touch screen mode associated with the specified input, and processing the voice input in accordance with the associated voice mode. However, the work fails to describe the selection and use of domain rule sets for the construction of field objects. Additionally, the work does not claim the use of domain rule sets for the construction of field objects as a method for more accurate and intelligent form completion.

Other work specifically references “field objects” and also describes application in the healthcare industry. Nonetheless, U.S. Patent Application US 2011/0238437 A1 to Zhou et al. titled “Systems and Methods for Creating a Form for Receiving Data Relating to a Healthcare Incident”, published Sep. 29, 2011, does not discuss converting utterances into field values. Furthermore, the work fails to describe the selection and use of domain rule sets for the construction of field objects. Finally, the work does not claim the use of domain rule sets for the construction of field objects as a method for more accurate and intelligent form completion.

All publications referenced herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

It should be noted that while much of the discussion herein is in regard to applications in the healthcare industry, the inventive subject matter is applicable in many other domains and market applications. One should appreciate the wide applicability of the described systems and methods to most form-filling activity. These applications may include but are not limited to the travel, legal, restaurant, hotel, law enforcement, accounting, military, journalism, pharmacy, psychologist and social worker markets.

Thus, there is still a need for an efficient spoken interface for intelligent data capture at point of origin, which is fully automated and minimizes disruption of the user's workflow.

### SUMMARY OF THE INVENTION

The inventive subject matter provides apparatus, systems and methods for collecting information at its point of origin and for filling out one or more predefined forms, through at least two techniques: (1) passively acquiring information during the course of a person(s)'s normal activities using a device to “eavesdrop” on the person(s), or (2) using an active spoken dialog interaction technique to collect information from the person to ensure completion of all required fields in the predefined forms.

The eavesdropping technique uses the same spoken dialog system architecture as the active dialog technique to interpret and process audio signals. However, the eavesdropping technique only updates field values for the predefined forms based on speech input, and displays the updated forms to the user. The active spoken dialogue technique, on the other hand, not only updates field values for the predefined forms, it also produces system queries triggered by form fields that are not completed during an interaction. The active spoken dialogue technique may also be used to prompt the user for more information and provide warnings to the user about possible errors in the data. The spoken dialog system preferably communicatively couples with databases, the internet and other systems over a network (e.g., LAN, WAN, Internet, etc.).

The inventive systems and methods take advantage of information in the speech that already occurs as part of a person's normal activities (e.g., a doctor's intake interview with a patient) thereby minimizing the additional interaction needed to complete the required electronic forms. The dialog interaction for completing any missing information also minimizes effort by providing a natural and flexible interface for entering information.

Another aspect of the inventive subject matter can include translating from speech to one or more customizable electronic forms format for a specific domain. As used herein, “domain” simply refers to a discipline, technical field, and/or subject matter that has a set of related data, information, or rules. Health care, for example, could be a domain since it may have a set of related data, information, or rules. Domains may be comprised of sub-domains or subclasses within the domain. For example, the health care domain may include a subclass for disease prevention, diagnostics, treatment, drugs and prescriptions, medical devices, and medical procedures. Constraining the functionality of an instantiation of the system to a specific domain has the advantage of significantly increasing the understanding accuracy of such system by incorporating domain knowledge.

Yet another aspect of the inventive subject matter includes the use of domain specific databases to support accurate speech recognition and natural language processing. Database information is used to build speech recognition language models. Information from domain specific databases which are accessible by the system also provides a basis for useful inferences relevant to the domain that would reduce errors in speech recognition, language processing, and form auto-filling. For example, in a clinical setting, a drug information database could supply information on dosage based on weight that would enable the system to check whether a dosage entered was within the recommended range for a patient's weight.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 illustrates the architecture of one embodiment of a multimodal dialog data capture system.

FIG. 2 illustrates one embodiment of a dialog engine interface.

FIG. 3 illustrates the data structures associated with an input signal mapping during a natural language understanding procession.

FIG. 4 illustrates the data structures associated with an input signal procession during a dialog management step.

FIG. 5 illustrates a method of filling a form using a multimodal dialog data capture system either in active or passive mode.

FIG. 6 shows a schematic of a multimodal dialog data capture system being used in the passive form filling mode.

FIG. 7 shows a schematic one embodiment of a multimodal spoken dialog interface operating in active mode.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

It should be noted that while the following description is drawn to a computer/server based interface systems, various alternative configurations are also deemed suitable and may employ various computing devices including servers, interfaces, systems, databases, agents, peers, engines, controllers, or other types of computing devices operating individually or collectively. One should appreciate that such terms are deemed to represent computing devices comprising a processor configured to execute software instructions stored on a tangible, non-transitory computer readable storage medium (e.g., hard drive, solid state drive, RAM, flash, ROM, etc.). The storage medium can include one or more physical memory elements, possibly distributed over a computing bus or a network. The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

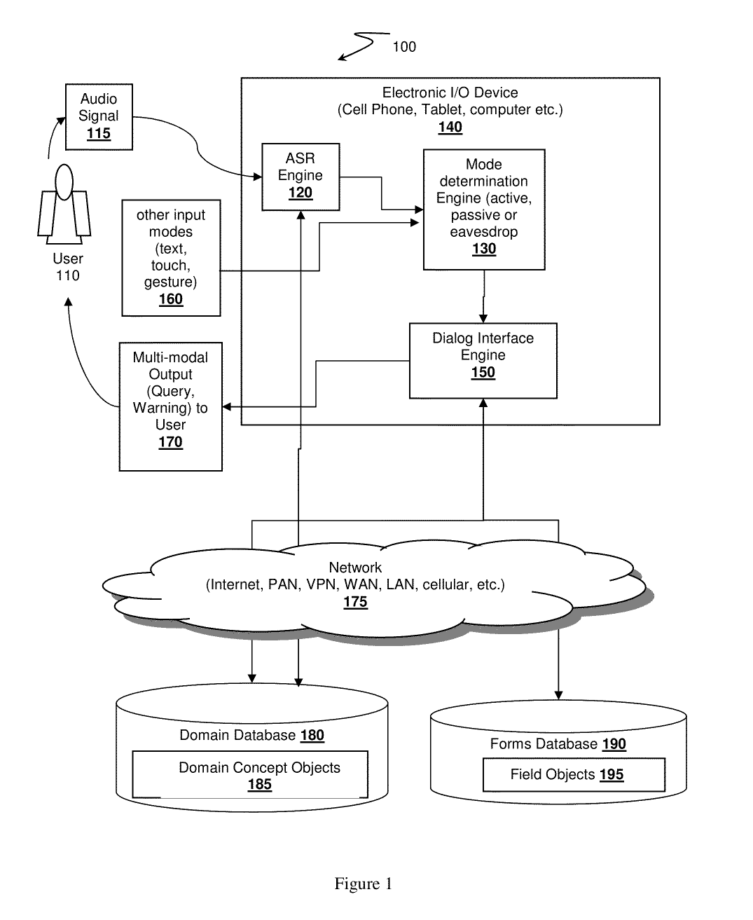

FIG. 1 depicts the architecture of a multimodal dialog data capture system 100. A user 110 speaks and the resulting audio signal 115 is sent to electronic device 140, which can be a cell phone, tablet, phablet, laptop computer, desktop computer, or any other electronic device suitable for performing the functions described below. Device 140 has an automatic speech recognition (ASR) engine 120, which converts the audio signal 115 to a set of N recognition hypotheses. The ASR engine 120 possibly utilizes domain specific acoustic and language models from the domain database 180. For example, if the system is intended for medical record filling during a patient-doctor interaction, a class-based, medical domain language model would be used where one class might comprise of medical procedure names and yet another class of drug names. The language model would include frequency-based weighting of class elements where weights might be usage frequencies of medical procedure or drug prescription frequencies. Utilizing domain specific acoustic and language models with weighted class elements helps to improve accuracy in recognizing language in audio signal 115.

Alternative to a spoken input signal, the input signal can also arrive to the device 140 via other input modalities 160, such as a touch screen input, keyboard input, or a mouse input. Independent of the input modality, device 140 determines the system mode using mode determination engine 130 (e.g., whether the system mode is active, passive, or eavesdrop.)

As used herein, the term “eavesdrop mode” means an electronic device will detect and map spoken words to domain rules and subsequently to field objects that will be stored as partially or completely filled form. In the eavesdrop mode, the electronic device will not present any spoken or visual output to the user. The eavesdrop mode also enables the user to dictate and have the interface extract material needed to populate the fields of the form.

As used herein the term “passive mode” means an electronic device will process an input signal if a magic word (e.g., a voice command) had been detected at the start of an input signal. In essence the magic word represents a verbal on/off switch and enables the user to control when the system should be listening. This has the advantage of minimizing the processing requirements during times when no relevant information is provided such as during social banter at the beginning of an appointment. Another advantage is to limit the likelihood of false positives, which are defined as instances where the system incorrectly extracts values from an input signal that do not contain any relevant information.

As used herein, the term “active mode” means the electronic device will interact with the user by generating spoken or visual outputs in addition to processing the input signal.

The input data and the system mode are passed on to the Dialog Interface Engine 150. The Dialog Interface Engine 150 maps the input signal to Domain Concept Objects 185. Domain concept objects 185 are a plurality of electronically stored data that represent domain concepts. Each of the Domain Concept Objects 185 may contain a number of components, which are stored in the Domain Database 180. Possible components of a domain concept object are (1) a domain specific regular expression rule set for extracting meaning from the input and (2) a set of domain objects that describe all or most information regarding a particular topic. A domain concept object could also comprise a set of variables as well as a set of trigger rules with associated actions. Such actions may include filling field objects in a form and providing instructions for assembling an output to user 110. Alternative actions may include providing instructions for handling error and confidence in language recognition. That is, based on confidence scoring of acoustic and semantic interpretation steps, the system might decide to confirm or correct a user input prior to displaying an updated output screen. Alternatively, the system might decide to display the user input along side with a suggested correction.

Often one piece of spoken input has the potential to fill fields in more than one active form and/or in more than one field within a form. In such cases the system will have one or more techniques for resolving which field to fill. Techniques for resolving which field or fields to fill using a particular spoken input include, but are not limited to: filling more than one field in one or more forms, selecting a single field by assigning probabilities or doing automatic classification based on the content of the forms, assigning probabilities or doing automatic classification based on a model of typical interactions, and/or using heuristics based on information from subject matter experts.

Information from domain specific databases may be used by all the components of system 100, including the ASR engine 120 and the Dialog Interface Engine 150. Data consisting of relevant terms and phrases are extracted from the databases and used to create the language model for the automatic speech recognition. Domain specific databases also provide information used to create probabilities, categories, and features for the natural language processing and the dialog processing.

The domain may also be constrained by the content of the form or forms that are loaded into the system. This constraint can be used to improve ASR and NLU accuracy. For example, if the single current active form covers diabetes management, then vocabulary and concepts related to allergy treatments can be excluded from the ASR and NLU models.

Once the Domain Concept Object 185 has been determined, the Dialog Interface Engine 150 also loads the Forms and Field Objects 195 from the Forms Database 190 that are associated with the current Domain Concept Object.

In alternative embodiments of system 100, domain database 180 and forms database 190 can be located within electronic device 140.

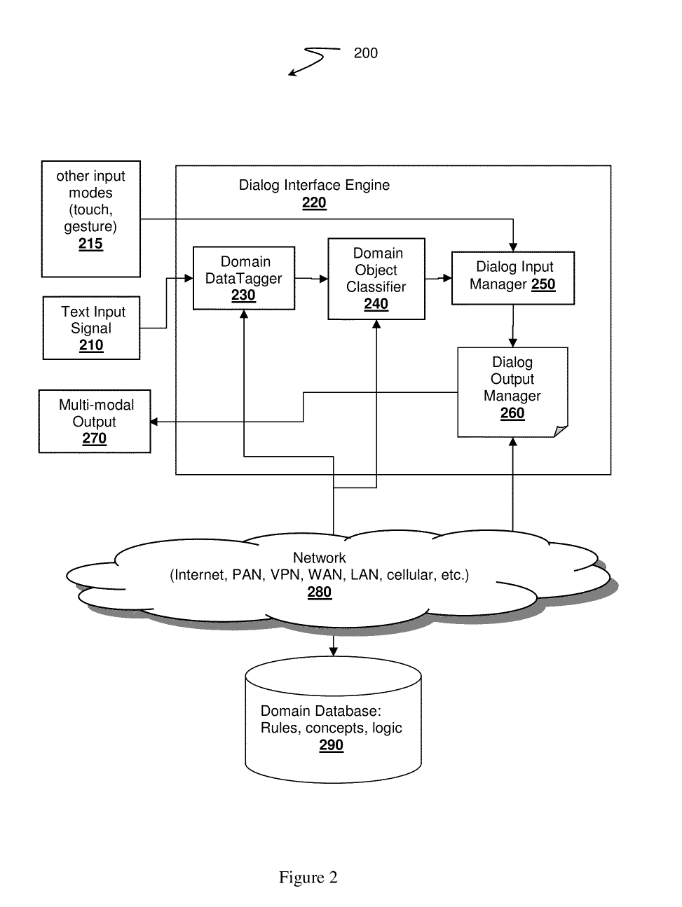

FIG. 2 depicts the architecture of a system 200 for interacting with a Dialog Interface Engine 220. Dialog Interface Engine 220 receives a Text Input Signal 210 from a user. Text Input Signal 210 can include both (i) a text entry provided by a user via an input device (e.g., touch screen, keyboard, etc.) and (ii) the output of an ASR Engine (e.g., N recognition hypothesis). Dialog Interface Engine 220 has a Domain Data Tagger 230 that receives Text Input Signal 210 and uses a set of domain specific regular expressions and domain data from the Domain Database 290 to mark up those parts of the Text Input 210 that match domain data. The access to the Domain Database 290 is via the Network 280. However, in alternative embodiments of system 200, Domain Database 290 can be located within an electrical device that houses both database 290 and dialog interface engine 220.

The output of the Domain Data Tagger 290 contains all matched data together with likelihood scores that encompass both acoustic as well as semantic confidence scores. For example, in the sentence ‘you have an ear infection’, ‘ear infection’ would be marked with DIAGNOSIS=‘otitis’ and the tagged sentence becomes ‘you have DIAGNOSIS=otitis’. As can be seen from this example, the tagging process can possibly contain a translation of the matched words to a common meaning value, e.g., if the user had said ‘you have otitis’, the tagged sentence would also be ‘you have DIAGNOSIS=otitis’.

Next, the tagged sentence is processed by the Domain Classifier 240, which utilizes data from the Domain Database 290, in particular a domain specific classifier model. This classifier model is typically created with the help of a set of tagged training sentences that have a target domain object associated with them. The Domain Classifier 240 classifies the tagged sentence to the most likely matching concept. Each concept in turn is mapped to a domain object.

Once the classification step is complete, the tagged N hypotheses with the associated matching concept are sent to the Dialog Manager 250. The input from other modalities 215 that do not contain statistical uncertainties are also sent to the Dialog Manager 250. The Dialog Manager processes all incoming data and compares it with the current active domain object(s). The active domain object(s) may contain domain specific trigger rules and instructions from the Domain Database 290 that instruct the Dialog Output Manager 260 how to assemble an Output 270 with its associated Field Object values. Output 270 can then be displayed to the user (e.g., via an electronic display, electronic communication, print out, etc.).

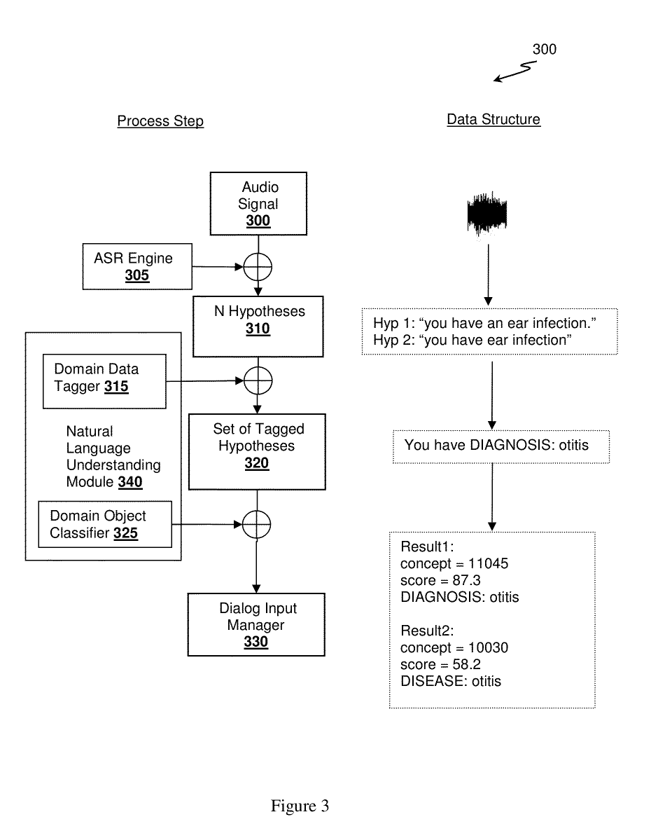

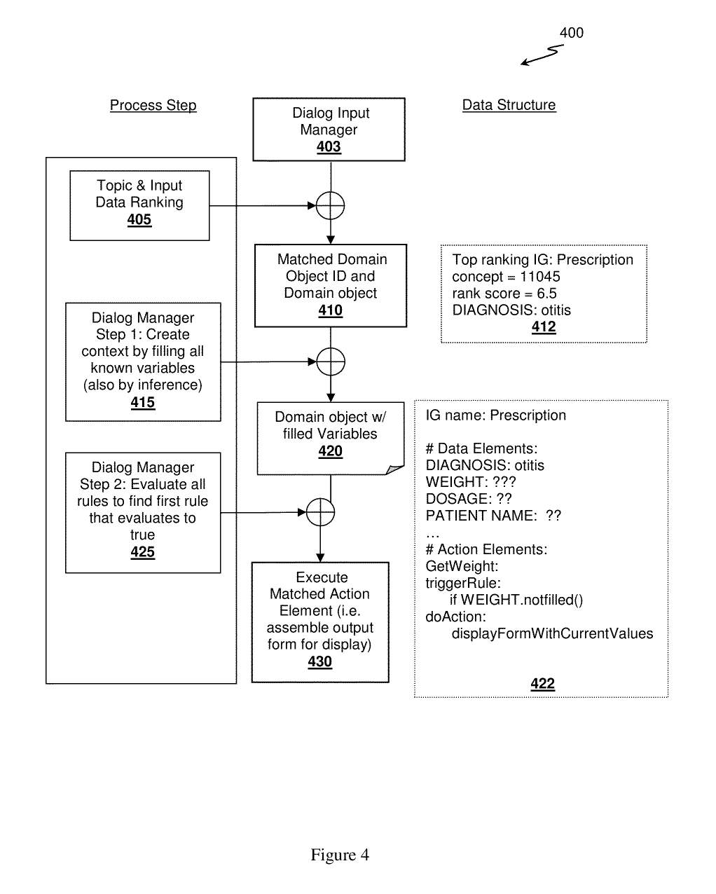

FIGS. 3 and 4 describe the different data structures that an audio input signal gives rise to during the understanding and dialog management process. FIGS. 3 and 4 are organized so that the various process steps are depicted on the left side and the corresponding data structure on the right hand side.

In FIG. 3, audio input signal 300 gets converted by the ASR Engine 305 to a set of N recognition hypotheses 310 (e.g., hypothesis 1 could be “you have an ear infection” and hypothesis 2 could be “you have ear infection”). In addition, the ASR engine may include domain specific signal processing depending of the usage configuration. For example, for form filling in a car repair garage environment, the ASR engine might include noise filtering specific to the noise characteristics in the garage. As another example, for scenarios in which multiple users are providing input, the ASR engine can be configured to recognize or identify two or more distinct human voices. The N recognition hypotheses 310 are then processed by Natural Language Understanding Module 340, which includes two steps. First, Domain Tagger 315 tags all matching data in the recognition hypotheses, resulting in a Set of Tagged Hypotheses 320. An example of such a tagged hypothesis would be ‘you have DIAGNOSIS: otitis’.

Next, the Topic Classifier 325 classifies each tagged hypothesis to the most likely topic. The classifier can be of any commonly known type such as Bayes, k-nearest neighbor, support vector machines and neural networks. (See, for example, the book titled “Combining Pattern Classifiers: Methods and Algorithms” authored by Ludmila I. Kuncheva, publisher John Wiley & Sons Aug. 20, 2004, which is incorporated herein by reference). The Domain Object Classifier 325 output, which also represents the Dialog Manager Input 330, comprises of a ranked lists of results, where each result has the following structure:
Result 1:
concept=11045
score=87.3
DIAGNOSIS: otitis
Result 2:
concept=10030
score=58.2
DISEASE: otitis

That is, each result contains the matching concept id number, the classifier score for the tagged hypothesis 320 to match the concept id number, and the matched data elements of the tagged hypothesis.

FIG. 4 illustrates the data structures that arise from the further processing steps of the input signal as part of the data processing within the Dialog Interface Engine. For each concept ID the Dialog Input Manager 403 looks up and/or creates a list of matching topics. Then, a ranking function is evaluated in order to determine the most likely topic and thus domain object for the current concept ID. The ranking function consists of a weighted sum of the classifier score, a topic priority rank, and the topic's position on the topic stack. Discussion of possible ranking mechanisms can be found in co-owned application having Ser. No. 13/866,444, titled “Multi-dimensional interactions and recall” filed Feb. 13, 2013, which is incorporated herein by reference.

An example ranking function would be:

$$Rank ( i ) = a * Matchedness ( i ) + b * Classifier Score ( i ) + c * stackPos ( i ) + d * expectFlag$$

where i indicates the ith domain object candidate, and a,b,c and d are weights that can be determined by training mechanisms such as linear regression. Matchedness is a measure to describe how well the set of input data matches the variables of the ith domain objects. For example if there are 3 input variables and one domain object matches 2 while another domain object matches all 3 input variables, then the second domain object will have a higher Matchedness score. Classifier Score(i) denotes the classifier confidence score for the ith domain object. stackPos(i) indicates a weight associated with the stack position of the current domain object. Note that the system always maintains a stack of domain objects with the currently active domain object being on the top. A domain object that is one position below the top will have a stackPos(i) weight of ½ and so forth.

Lastly, domain object variables can have an ‘expected’ flag. If input data matches the variable of the currently active domain object that has the ‘expected’ property set, then the expectFlag will have the value of 1 otherwise 0. This mechanism is used, for example, to mark a variable for which an answer is being expected in the next turn. This ranking process results in a combination of matched Concept ID and domain object in the data structure as shown in box 412.

Next, the first step of the Dialog Manager 415 is to create the context for the input data. This is done by first filling the variables associated with the top-ranking domain object with the matched data elements of the tagged hypothesis. In a second filling pass, all inference rules associated with variables are executed in order to fill additional variables of the current domain object by interference. For example, if the user said ‘come back for a blood test on the fifth,’ the month will be inferred and either the current or the next month depending on the current date. This first step of the Dialog Manager 415 results in a domain object with filled variables 420. Box 422 shows an example of the data structure of a partially filled domain object.

Step 2 of the dialog manager is to evaluate all trigger rules in the domain object. The actions associated with the first trigger rule that evaluates to true are then executed. The most common action is to assemble an output form for display. In this step, the field objects associated with the output form are filled with the variable values from the currently active domain object and the device is configured for the display of this output form.

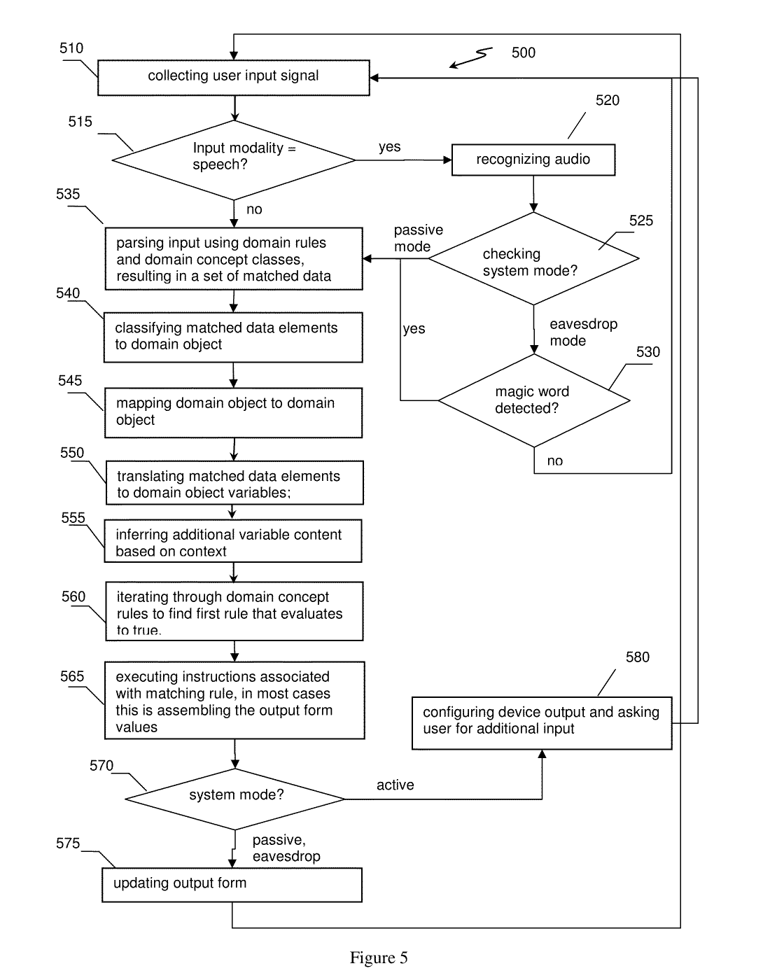

FIG. 5 depicts a method of output form updating based on an input signal. First, in step 510 the user input signal is collected. The system then checks the input modality, as shown by step 515. If the input modality is speech, the system proceeds with recognizing the audio signal in step 520. Following this, the system mode is checked in step 525. If the system is in passive mode, the recognition result is checked for the magic word in step 530. If the user had not used this magic word, which serves as a trigger to start processing the following words, the system returns to step 510—that is returning to waiting for new audio input.

In the case the audio contained the magic word, the next step 535 is to parse the input using domain rules and domain concept classes. Step 520 is also being reached in the case that the input signal had been text or touch. The resulting set of matched data from step 535 is then classified in order to identify the most likely matching domain concept object, as shown in step 540. Next, the domain concept object is mapped to a domain object in step 545. In step 550, the matched data elements that were associated with the domain concept object are then translated to domain object variables, followed by inferring additional variable content based on context in step 555.

Once the domain object variable filling is complete, the domain object one-by-one evaluates all trigger rules in step 560. The action rules that are associated with the first trigger rule that evaluates to ‘true’, are then executed in step 565. In most cases this comprises of filling the field objects for an output form. In the case that the system is in active mode per the mode check of step 570, the output device will be configured as shown in step 580. Step 580 may also include the task of asking the user for additional information, if such a task is included in the action rules that are being evaluated. If the system mode denotes a system in either passive or eavesdrop mode, the output form will be updated in step 575. After completion of both step 575 and step 580, the system returns to listening for and collecting of the next user input signal (i.e., step 510).

One should appreciate that the disclosed techniques provide many advantageous technical effects including translation from natural speech to structured data, a method that ensures required data is entered, and effective use of speech that occurs during normal performance of the primary task. The disclosed techniques allow for a unique combination of passive and active data collection. That is, a system can passively collect data and only becomes interactive with a user if an error in the form filling or a business rule violation has occurred. For example, a system that is being used during a doctor's appointment may passively collect data during the patient consultation until the system Dialog Interface Engine 150 determines that an error in the prescription dosage has occurred or if at session end there are still missing data. In that case, the system may become active by interacting with the user (e.g., notifying the doctor of the error in prescription dosage or prompting the doctor to provide more information).

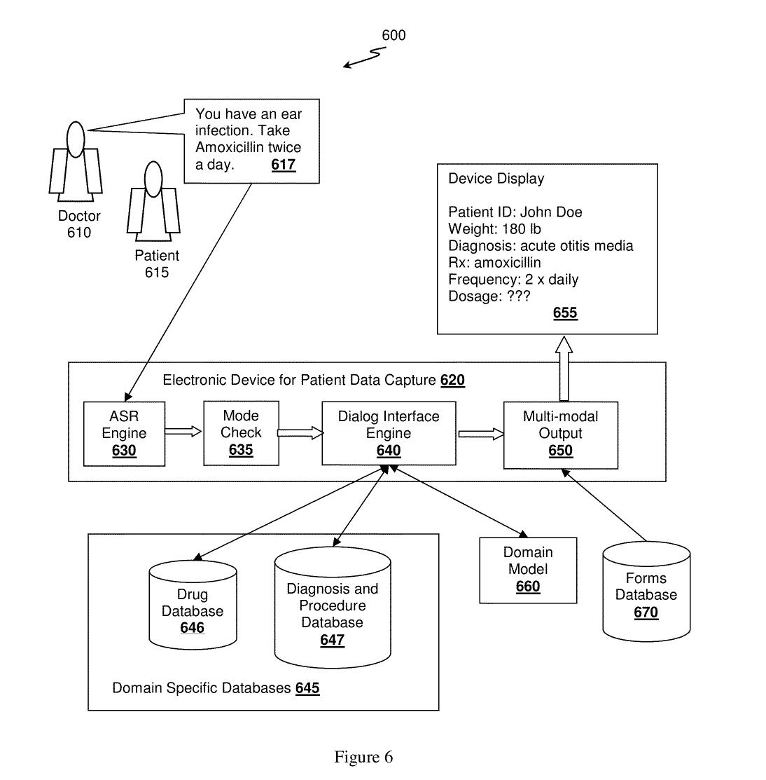

FIG. 6 shows use-case for a multimodal dialog data capture system 600, in which a doctor 610 is conducting a medical examination of patient 615 and the system 600 is running on an electronic device 620 nearby. Suppose that the doctor 610 speaks the input signal 617 “You have an ear infection. Take amoxicillin twice a day” and device 620 is running in eavesdrop mode. (Note that, were the system running in passive mode, the doctor would have to preface his statement with the magic word, e.g., ‘NOTE, take amoxicillin for 14 days’, where the word ‘NOTE’ is recognized by device 620 as voice command to switch from passive mode to eavesdrop mode.) Device 620 then receives and processes input signal 617. More specifically, ASR Engine 630 performs a check for the current mode 635, and then processes the recognized input with the Dialog Interface Engine 640. The Dialog Interface Engine 640 understands that the input 617 is about a diagnosis, based on its usage of both the Domain Specific Databases 645, in this example a Drug Database 646 and a Diagnosis and Procedure Database 647 and the Domain Model 660. In the last step, the multi-modal output is being assembled based on current context, the input signal 617, and information from the Forms Database 670.

The inventive subject matter is also considered to include mapping from spoken input to procedural codes, such as current procedural terminology (CPT), international classification of diseases (ICD), and/or other types of codes. As a health care provider interacts with a patient in a natural manner, the interface system can suggest or recommend one or more procedural codes for the patient visit. Such codes can then be used for billing or reimbursement.

Only at this point in time will the system behavior be different depending on whether it is running in active or eavesdrop mode. In eavesdrop mode, the output will only be an updated Device Display 655. In active mode the output might also include the system reading out the updated display information or the system asking a question or even providing a warning to the user. Switching between the three different modes (e.g., active, passive and eavesdrop) can be done in a number of different ways. In some embodiments, the user is presented with a drop-down menu on the electronic device for switching between the modes. In other embodiments, the electronic device is configured to respond to voice commands like ‘switch to active mode’ to request a mode change on the electronic device.

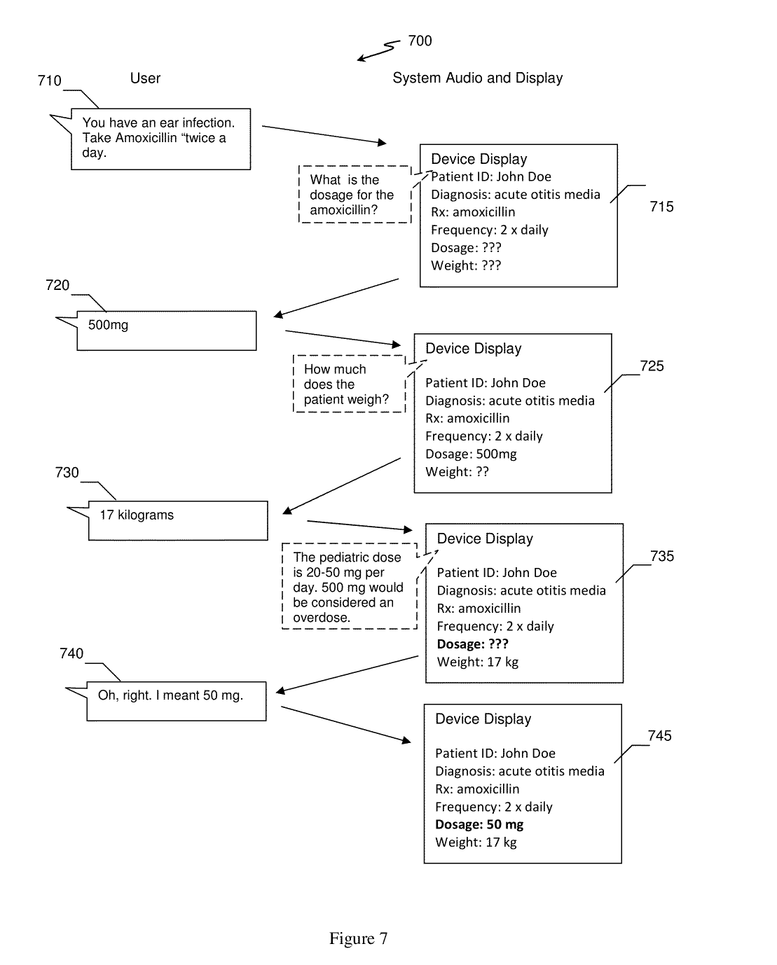

Now consider the same use-case as in FIG. 6 but with the system running in active mode as shown in FIG. 7. Imagine the heath care provider has finished the exam, and now wants to interact with the system in order to complete the record. The health care provider might switch the system mode to active by saying ‘Computer, switch to active mode’. Switching to active modes means that the will now query for missing information and also be tasked with monitoring the data input for correctness and completeness. Since up to the current moment in time, no value had been captured for dosage, the system asks for it by outputting an audio signal such as “What is the dosage for the amoxicillin?” The user provides the data by speaking a value such as “500 mg,” which is interpreted by the ASR engine and Dialog Interface Engine, and then inserted into the appropriate field in the form and displayed to the user. Dialog Interface Engine The domain model provides information that this is an acceptable adult dose so no out of range problem is indicated. The system queries for the next empty field which is weight. The user's response “seventeen kilograms” is filled in as the value for weight on the display. At this point the domain model provides information that this weight is small enough to indicate a pediatric patient and the system will display and speak an out of range warning for the dosage. The user corrects the error and the new value “50” replaces the previous value “500” on the display.

Just as the system performs error corrections, if the patient or doctor notices that some information is incorrect, they have the ability to speak an appropriate correction and the system will update the display accordingly. Furthermore, note that the inventive subject matter described here is capable of completing multiple forms and is capable of switching between partially completed forms due to the ranking mechanism described in the paragraphs above. For example, a health care provider might be in the middle of filling out a prescription when she realizes that she wants to look up prior dosage amounts in the medical records of the patient. The health care provider can do this by simply asking the question “What dosage did John Smith have the last time he was prescribed Amoxicillin?” The system will process, understand, and look up the required information, display it on the screen, and potentially read it out. If then the health care provider says “ok, please add the same dosage to the new prescription”, the ranking function will place the ‘fill prescription’ domain object on top of the stack and execute against it.

One should further appreciate that the system is configurable for a variety of tasks, including but not limited to medical record keeping, insurance reporting and clinical study data capture. This configurability is achieved by having intelligent behavior including but not limited to validation of values within and across fields, be driven by the information in the domain model and information in the domain specific databases. In addition the system has the ability to load different forms. The inventive subject matter can also be applied in all situations where two or more people interact about a specific task or domain and where record-keeping of the interaction is required. For example, technical support, technical diagnostics, warehousing, meetings with a lawyer.

Another use case of a multimodal dialog data capture system would be filling out loan application papers. In this case a loan officer would be sitting with the client and asking the client for the information. This use case illustrates how the system can utilize and process input signals from multiple users. For example, when the loan officer asks “What is your home address” the system knows which piece of information to expect next, i.e. the client's home address. This has the advantage that in the case that there are multiple addresses in a form; the system does not have to disambiguate which address was meant. The system could have the same architecture as in FIG. 6, with the difference that the database and domain model that are required will contain financial or loan-specific information, rule sets, language models and so forth. The forms database will contain all forms pertaining to a loan application.

Yet another use case of a multimodal dialog data capture system may be in a mechanic's garage where a client interacts with the mechanic to set up a car repair and to pick up the car after repair completion. In this case the domain database will contain language models around the language used in the automobile environment and the acoustic models will be customized for the kind of noise and acoustics that are typical in a garage environment. The ASR engine will also include domain specific noise processing. For example, multiple microphones could be place in different locations of the garage, and the input signal will comprise the aggregate of the acoustic signal from all microphone sources. The ASR engine may include a noise filtering preprocessor that merges all audio signals and applies noise filtering.

In a mechanic garage scenario the domain concept objects may contain rules around part and labor pricing, as well as backend connectivity to order replacement parts. In addition, domain concept objects may include how to send out notifications about repair completion to the client. The forms being used may be repair order forms, repair notes, and forms to order replacement parts. The domain concept object for the repair order form would be configured so that the client speaks personal data such as phone number and a problem description as to what is wrong with the car. The domain object would have other rules to ensure that the mechanic properly completes and submits the form. The domain objects may also include rules that ensure a proper diagnosis and repair are selected and performed by the mechanic.

Other domain objects would cover ordering parts. Those domain objects would be receiving context data from other domain objects. For example, if the repair order domain object receives information that a repair includes a part and a backend check determines that a part is not in stock that would automatically fire the part ordering domain objects.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their end-points, and open-ended ranges should be interpreted to include commercially practical values. Similarly, all lists of values should be considered as inclusive of intermediate values unless the context indicates the contrary.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document the terms “coupled to” and “coupled with” are also used to convey the meaning of “communicatively coupled with” where two networked elements communicate with each other over a network, possibly via one or more intermediary network devices. It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A multimodal dialog data capture system comprising:
at least one domain specific database storing domain concept objects;
at least one forms database storing field objects related to one or more forms; and
a dialog interface coupled with the domain specific database and forms database and configured to:
collect an input signal from a user, the input signal comprising at least speech;
map the input signal to a domain object according to a selected domain rules set;
map the input signal to a field object of a form according to the selected domain rules set;
translate the input signal to at least one field value as a function of the domain object, field object, and the selected domain rules set; and
configure a device to capture the at least one field value within the field object associated with the form.

2. The system of claim 1, wherein the dialog interface is further configured to passively collect the input signal from the user.

3. The system of claim 2, wherein the dialog interface is further configured to eavesdrop on the user.

4. The system of claim 1, wherein the dialog interface is further reconfigured to actively collect the input signal from the user.

5. The system of claim 4, wherein the dialog interface is further configured to have an interaction with the user.

6. The system of claim 5, wherein the interaction comprises at least one of the following: a query to the user, a warning to the user, and an input from the user.

7. The system of claim 1, wherein at least some of the domain concept objects are medical domain concept objects.

8. The system of claim 7, wherein the medical domain concept objects relate to at least one of the following: a diagnosis, a prognosis, a prescription, a procedure, a drug, a treatment, a therapy, a referral, a clinic, a service, and a medical device.

9. The system of claim 1, wherein the field value comprises a procedural code.

10. The system of claim 9, wherein the procedural code comprises at least one of a CPT code, ICD code, a proprietary code, a billing code, and a HCPCS code.

11. The system of claim 1, wherein the device comprises at least one of the following: a smart phone, a computer, a tablet computer, a medical examination device, a sensor, a biometric device, a safety monitoring device, a laboratory device, and a drug delivery device.

12. The system of claim 1, further comprising at least one external data source configured to supply data in support of translating the at least one field value.

13. The system of claim 12, wherein the at least one external data source comprises at least one of the following: an electronic medical record database, a web server, a patient device, a drug database, a billing database, a diagnosis database, an insurance database and a therapy database.

14. The system of claim 1, wherein the dialog interface comprises multimodal sensors and wherein the input signal comprises a digital representation of modalities other than speech.

15. The system of claim 14, wherein the digital representation comprise at least one of the following types; modal data: text data, visual data, kinesthetic data, auditory data, taste data, ambient data, tactile data, haptic data, time data, and location data.
